(19) United States
(12) Patent Application Publication
(10) Pub. No.: US 2012/0273249 A1
(43) Pub. Date: Nov. 1, 2012

(54) CABLE HAVING WELDABLE SHIELD

(76) Inventor: HUA-WEI CHEN, PINGZHEN CITY (TW)

(21) Appl. No.: 13/096,268

(22) Filed: Apr. 28, 2011

(51) Int. Cl. H01B 9/02

(52) U.S. Cl. 174/107

(57) ABSTRACT

The present invention relates to a cable having weldable shield and includes an insulating plastic jacket being a hollow tube made of an insulation material, such as PVC, PE, XLPE or PU; at least one core wire being correspondingly located in the insulating plastic jacket to axially extend therethrough for power or signal transmission; and a shield being correspondingly provided inside the insulating plastic jacket to axially extend therethrough and being located outside the core wire for shielding electromagnetic wave. The shield can be a braided shield formed by braiding strands of wires on a multi-carrier wire-braiding machine, of which the number of carriers can be determined according to actual need. And the wires on at least one of the carriers are weldable wires.

### FIELD OF THE INVENTION

The present invention relates to a cable having weldable shield, and more particularly to a cable that has a shield weldable to an iron housing and capable of suppressing electromagnetic interference (EMI).

### BACKGROUND OF THE INVENTION

Thanks to technological progress, various kinds of electronic products have become highly popular and widely applied in people's daily life. Electronic products often require cables to transmit power or signal. To avoid electromagnetic interference (EMI) between different electronic products, the electronic products usually include a cable that is provided, for example, inside an insulating sheath thereof and outside a core wire thereof with a metal braided or spiral shield.

According to the currently available techniques, the shield for cable used with electronic products may be a braided shield formed by braiding copper, magnesium or aluminum strands of wires on a wire-braiding machine having, for example, 16 carriers, 24 carriers or other number of carriers, or a spiral shield formed by helically wrapping copper, magnesium or aluminum wires around a core wire of the cable. The shield so produced is in the form of a sleeve located inside and axially extended through a full length of the cable. However, the cable having a shield completely made of copper wires requires very high cost and is not easily acceptable for using in wide applications. On the other hand, the cable having a shield made of aluminum or magnesium wires provides only limited EMI coverage to become functionally insufficient for use, and therefore, in most cases, further requires an additional drain wire 90, as shown in FIG. 1. The additional drain wire 90 would no doubt disadvantageously increase the manufacturing cost of the cable. In view of the aforesaid problems, it is tried by the inventor to develop a cable having weldable shield that overcomes the drawbacks in the prior art cables and is industrially more practical for use.

### SUMMARY OF THE INVENTION

A primary object of the present invention is to provide a cable which has weldable shield and conforms to patentability requirements comprising novelty and originality and industrial applicability so as to overcome the drawbacks in the conventional cables.

To achieve the above and other objects, the cable having weldable shield according to the present invention includes:

an insulating plastic jacket in the form of a hollow tube made of an insulation material; at least one core wire being correspondingly located inside the insulating plastic jacket to axially extend therethrough for power or signal transmission; and a shield being correspondingly located inside the insulating plastic jacket to axially extend therethrough and being located outside the core wire for shielding electromagnetic wave. In an embodiment of the present invention, the shield is formed by braiding strands of wires on a wire-braiding machine with multiple carriers, and the wires on at least one of the carriers are weldable wires.

According to the present invention, the wires on all other carriers are aluminum wires or magnesium wires, and the weldable wires are copper wires or tinned copper wires. Further, the shield is braided on a wire-braiding machine having 16, 24 or other number of carriers, and the strands of wires on each of the carriers are five in number. The cable having weldable shield according to the present invention may further include a wrapping layer being correspondingly located inside the shield to axially extend therethrough and being located outside the core wire, and the wrapping layer is aluminum foil. According to the present invention, the insulating plastic jacket can be made of polyvinylchloride (PVC) or poly(vinyl ethylene) (PVE), halogen-free materials, etc. And, the insulating plastic jacket is a round tube.

In the cable having weldable shield according to the present invention, aluminum or magnesium wires are used to form a basic structure of the shield, and weldable copper wires are used at the same time to be braided along with the aluminum or magnesium wires. With this design, the resulting cable product can provide increased shield efficiency without increasing the manufacturing and raw material costs thereof. Further, the copper wires in the shield may be used for welding to an iron case to not only provide increased electromagnetic interference (EMI) shield efficiency but also serve as grounding.

With these and other objects, advantages, and features of the invention that may become hereinafter apparent, the nature of the invention may be more clearly understood by reference to the detailed description of the invention, the embodiments and to the several drawings herein.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a cross-sectional view of a prior art cable;

FIG. 2 is a cross-sectional view of a cable having weldable shield according to a preferred embodiment of the present invention; and

FIG. 3 is a sectional perspective view of the cable having weldable shield shown in FIG. 2.

### DETAILED DESCRIPTION OF THE PREFERRED EMBODIMENTS

The present invention will now be described with a preferred embodiment thereof and with reference to the accompanying drawings. For the purpose of understanding easily, elements that are the same in the drawings are denoted by the same reference numerals. It is understood the accompanying drawings are illustrated only for assisting in describing the present invention and are not necessarily in compliance with the exact or precise size proportion and part arrangement of a real product manufactured through implementing the present invention. Therefore, the size proportion and part arrangement shown in the accompanying drawings are not intended to interpret or limit the present invention, which is intended to be limited only by the appended claims.

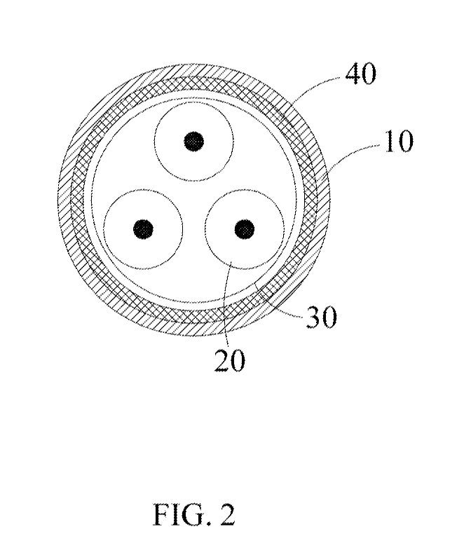

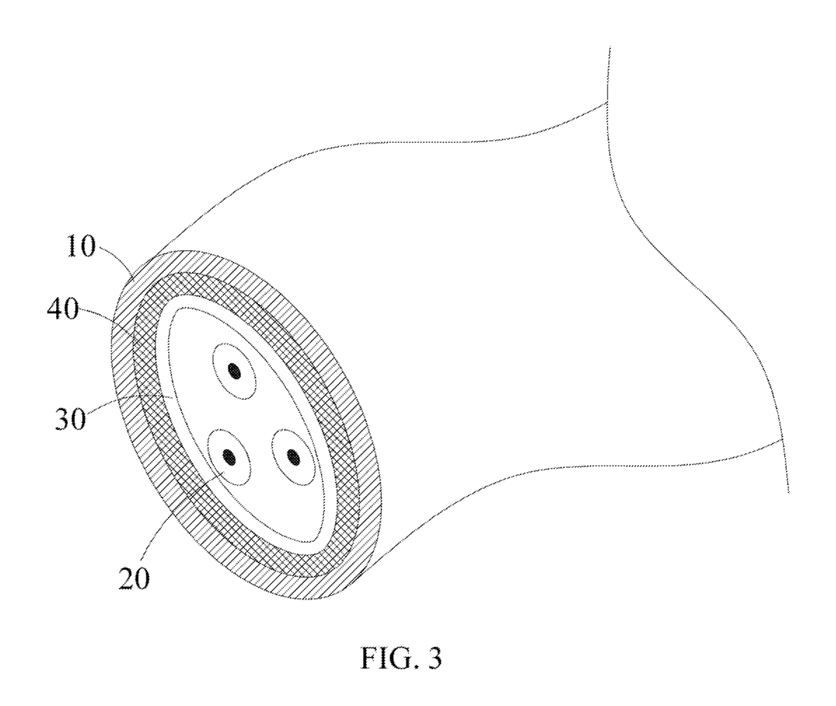

Please refer to FIGS. 2 and 3. A cable having weldable shield according to a preferred embodiment of the present invention includes an insulating plastic jacket 10, at least one core wire 20, a wrapping layer 30, and a shield 40. The insulating plastic jacket 10 may be made of polyvinylchloride (PVC), polyethylene (PE), crosslinked polyethylene (XLPE) or polyurethane (PU).

The insulating plastic jacket 10 is a hollow round tube made of an insulation material, such as a PVC material.

The core wires 20 are correspondingly located inside the insulating plastic jacket 10 to axially extend therethrough for power or signal transmission.

The wrapping layer 30 is correspondingly provided inside the insulating plastic jacket 10 to axially extend therethrough and is located outside the core wires 20. The wrapping layer 30 may be formed of aluminum foil.

The shield 40 is correspondingly located inside the insulating plastic jacket 10 to axially extend therethrough and is located outside the wrapping layer 30 for shielding electromagnetic wave. The shield 40 may be a braided shield formed by braiding strands of wire on a wire-braiding machine having multiple carriers, such as 16 carriers, 24 carriers or other number of carriers, and the strands of wires on each of the carriers may be five in number. The wires on at least one of the carriers may be weldable wires, such as copper wires, tinned copper wires or other metal wires, while the wires on all other carriers are aluminum wires or magnesium wires. Alternatively, the shield 40 may be a spiral shield formed by helically wrapping wires around interior of the insulating plastic jacket 10.

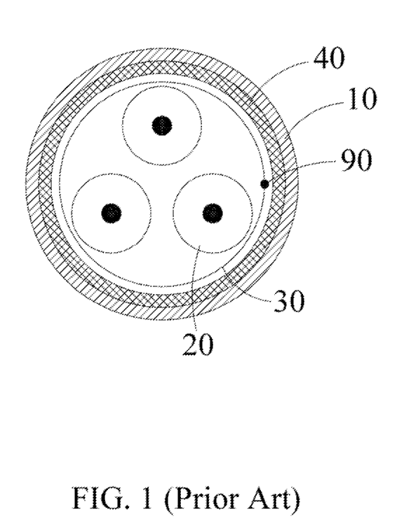

In the cable having weldable shield according to the present invention, aluminum or magnesium wires are used as a basic structure of the shield, and weldable copper wires are used at the same time to be braided along with the aluminum or magnesium wires. With this design, the resulting cable product can provide increased shield efficiency without increasing the manufacturing and raw material costs thereof. Further, the copper wires in the shield may be used for welding to an iron housing to not only provide increased electromagnetic interference (EMI) shield efficiency but also serve as grounding. The present invention is superior to the prior art cable because the drain wire 90 required in the prior art cable as shown in FIG. 1 can be omitted from the cable of the present invention, enabling the cable of the present invention to have reduced manufacturing cost and be more advantageously used in different applications. Thus, the present invention overcomes the drawbacks of the prior art and conforms to originality.

The present invention has been described with a preferred embodiment thereof and it is understood that many changes and modification in the described embodiments can be carried out without departing from the scope and the spirit of the invention that is intended to be limited only by the appended claims.

What is claimed is:

1. A cable having weldable shield, comprising:
an insulating plastic jacket being a hollow tube made of an insulation material;
at least one core wire being correspondingly located in the insulating plastic jacket to axially extend therethrough for power or signal transmission; and
a shield being correspondingly located inside the insulating plastic jacket to axially extend therethrough and being located outside the core wire for shielding electromagnetic wave;
wherein the shield is selected from the group consisting of a braided shield and a spiral shield; wherein the braided shield is formed by braiding strands of wires on a wire-braiding machine having multiple carriers, and the spiral shield is formed by helically wrapping wires around interior of the insulating plastic jacket; and wherein the wires on at least one of the carriers are weldable wires.

2. The cable having weldable shield as claimed in claim 1, wherein the wires on all other carriers are selected from the group consisting of aluminum wires or magnesium wires.

3. The cable having weldable shield as claimed in claim 2, wherein the weldable wires are selected from the group consisting of copper wires or tinned copper wires.

4. The cable having weldable shield as claimed in claim 3, wherein the strands of wires on each of the carriers of the wire-braiding machine are two or more in number.

5. The cable having weldable shield as claimed in claim 3, further comprising a wrapping layer being correspondingly located inside the shield to axially extend therethrough and being located outside the core wire.

6. The cable having weldable shield as claimed in claim 5, wherein the wrapping layer is formed of aluminum foil.

7. The cable having weldable shield as claimed in claim 3, wherein the insulating plastic jacket is made of a material selected from the group consisting of polyvinylchloride (PVC), polyethylene (PE), crosslinked polyethylene (XLPE) or polyurethane (PU).

8. The cable having weldable shield as claimed in claim 3, wherein the insulating plastic jacket is in the form of a round tube.

9. The cable having weldable shield as claimed in claim 3, further comprising a drain wire inside the insulating plastic jacket.
